(19) United States
(12) Patent Application Publication
(10) Pub. No.: US 2005/0262145 A1
(43) Pub. Date: Nov. 24, 2005

(54) System, method and program for news updates

(75) Inventor: Miho Kawano, Tokyo (JP)

Correspondence Address: GREENBLUM & BERNSTEIN, P.L.C., 1950 ROLAND CLARKE PLACE, RESTON, VA, 20191, US

(73) Assignee: DWANGO CO., LTD., Tokyo (JP)

(21) Appl. No.: 10/950,442

(22) Filed: Sep. 28, 2004

(30) Foreign Application Priority Data
May 19, 2004 (JP) 2004-149712

(51) Int. Cl. G06F 7/00

(52) U.S. Cl. 707/104.1

(57) ABSTRACT

In order to easily obtain news follow-ups which one reads and is interested in, with a portable terminal, event identification information is correlated to news events to be aired on TV, and stored in a master information storage of a server. This makes it possible to selectively provide news events stored in the master information storage when a request for news events is received from a mobile phone. During a news broadcast, upon selection of an event with the mobile phone, the master information storage is accessed, and an event ID is stored in association with a user ID in a user information storage of the server. Upon an event update, the user information storage is accessed, the event ID associated with the updated event is identified, and news information regarding the updated event is provided as a follow-up or update.

The present invention relates to subject matter contained in Japanese Patent Application No. 2004-149712, filed on May 19, 2004 the disclosure of which is expressly incorporated herein by reference in its entirety.

### BACKGROUND OF THE INVENTION

1. Field of the Invention

The present invention relates to a system, method and program for news follow-ups or updates.

2. Description of the Prior Art

A news follow-up or update notification system is presently available which distributes the latest news regularly to portable terminals such as mobile telephones. In this case, a user needs to register in advance his/her mail address for his/her portable terminal in a news distribution web site. This permits him/her to receive the latest news at his/her registered mail address from the distribution web site. Meanwhile, a system for distributing news in accordance with a user's preference has been also proposed in Japanese Published Unexamined Patent Application No. 2001-350790.

As for news distributed to users, a conventional news follow-up notification system classifies the news by genre or subject and changes the news every day and the users can therefore scan the minimum necessary news broadly yet shallowly. In the case of news distributed on a daily basis in particular, since the priority is determined every day on a news distribution web site, even the same piece of news would not always appear on the top page. News a user is interested in does not always appear on the top page, and it is up to the user to decide whether to search for news. Even if news distribution in line with user's preference is possible, it is difficult to distribute news relevant to a particular event.

### SUMMARY OF THE INVENTION

An object of the present invention is to provide a news follow-up notification system, method and program which allows one to easily obtain, on his portable terminal, news follow-ups which he/she reads and has interest in.

One aspect of the present invention is directed to a news follow-up notification system for use with a portable terminal in a telecommunications network. The system comprises a master information storage which stores event identification information correlated to news events aired on TV, and a news provider which selectively provides news information for individual news events stored in the master information storage, in response to a request from a portable terminal. The system also comprise a user information storage which stores user identification information and correlated address information for registered users, reads event identification information associated with an event selected via the portable terminal from the master information storage, and stores the event identification information in association with the user identification information.

The system also comprises a matcher which, upon updating of an event stored in the master information storage, refers to the user information storage and identifies the event identification information associated with the updated event. The system also comprises a follow-up notifier which refers to the user information storage when the matcher has identified the event identification information, extracts address information associated with the identified event identification information, and provides notification of a follow-up news event using the extracted address information.

In one embodiment of the invention, the follow-up notifier notifies the portable terminal in the form of mail. In another embodiment, the follow-up news event includes an article on the event, and the follow-up notifier embeds the article in the text of the mail. In another embodiment, the follow-up news event includes an airing schedule of a program which provides a follow-up on the event, and the follow-up notifier provides the airing schedule of the program in the text of the mail. In another embodiment of the invention, the follow-up notifier notifies prior to airing of the program.

Another aspect of the invention is directed to a news follow-up notification method for use with a portable terminal in a telecommunications network. The method comprises storing, in a first memory, event identification information correlated to individual news events aired on TV, and selectively providing news event information stored in the first memory in response to a request from a portable terminal. The method also comprises storing, in a second memory, user identification information and correlated address information for registered users, and reading out event identification information associated with an event selected via the portable terminal from the first memory.

The method also includes storing the event identification information in association with the user identification information, referring to the second memory upon updating of an event stored in the first memory, and identifying event identification information associated with an updated event. The method also includes referring to the second memory when the event identification information has been identified, extracting address information associated with the identified event identification information, and providing notification of a follow-up news event regarding the updated event in accordance with the address information.

In one embodiment of the invention, notification is provided in the form of mail. In another embodiment, the follow-up event includes an article on the event, and the article is embedded in the text of the mail. In another embodiment, the follow-up news event includes an airing schedule of a program which provides a follow-up on the news event, and the airing schedule of the program is embedded in the text of the mail. In another embodiment, notification is provided prior to airing of the program.

Another aspect of the invention is directed to a news follow-up notifying program which can be executed by a computer on a server which communicates with a portable terminal via a network. The program operations comprise storing, in a first memory, individual event identification information related to news information aired on TV, and selectively providing individual news event information stored in the first memory to a portable terminal in response to a request from the portable terminal. The operations also comprise storing, in a second memory, user identification information and correlated address information for each registered user, and reading out event identification information associated with the event selected from the first memory when an event is selected by the portable terminal.

The operations also comprise storing the event identification information thus read in association with the user identification information, and referring to the second memory upon updating of an event stored in the first memory. The operations also comprise matching the event identification information with the updated event, and referring to the second memory when matching event identification information has been obtained. The operations also comprise extracting address information associated with the matching event identification information, and notifying, as a follow-up, news information regarding the updated event in accordance with the extracted address information.

In one embodiment, notification is provided in the form of mail. In another embodiment, the news information includes an article on the event, and the article is embedded in the text of the mail. In another embodiment, the news information includes an airing schedule of a program which will give a follow-up on the event, and the airing schedule of the program is embedded in the text of the mail. In another embodiment, notification is provided prior to airing of the program.

### BRIEF DESCRIPTION OF THE DRAWINGS

FIG. 1 is a drawing showing one example of a network system containing the news follow-up notification system of the present invention;

FIG. 2 is a drawing for describing the program schedule of the present invention;

FIG. 3 is a block diagram which shows an example of the structure of the mobile phone of the present invention.

FIG. 4 is a block diagram which shows an example of the structure of the server of the present invention;

FIGS. 5A & 5B are drawings for describing the information which is stored in the server;

FIG. 6 is a drawing for describing the information which is stored in the server;

FIGS. 7A, 7B, 7C & 7D are drawings for describing one example of screen change of the present invention;

FIG. 8 is a flow chart for describing the follow-up requesting method of the present invention;

FIG. 9 is a flow chart for describing the update processing between the broadcasting station control apparatus and the server of the present invention; and

FIG. 10 is a flow chart for describing the follow-up receiving method of the present invention.

### DESCRIPTION OF THE PREFERRED EMBODIMENTS

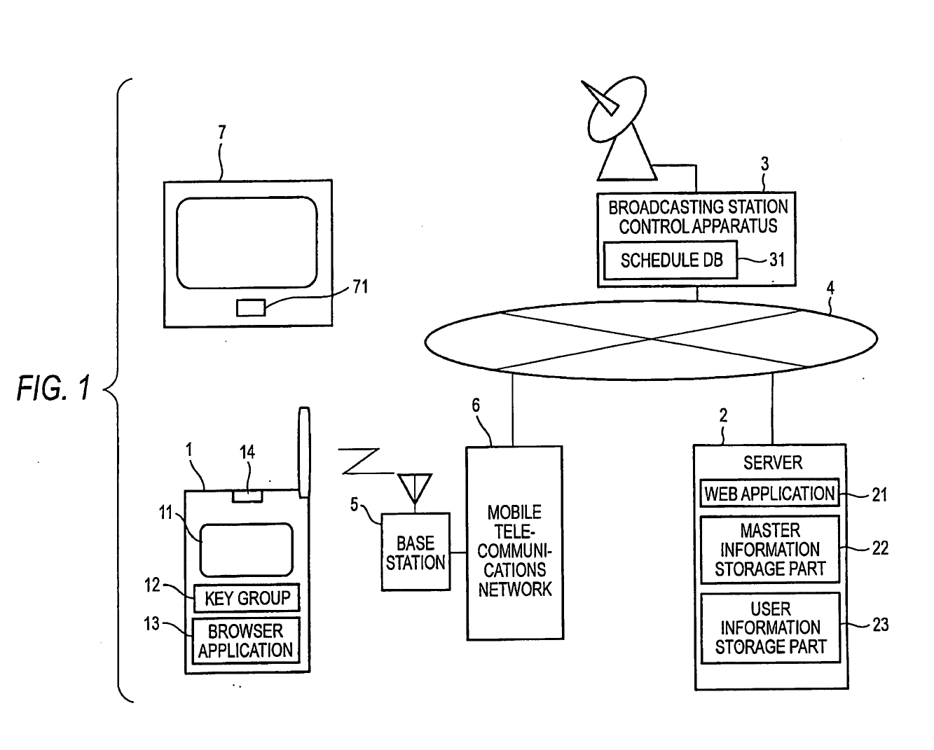

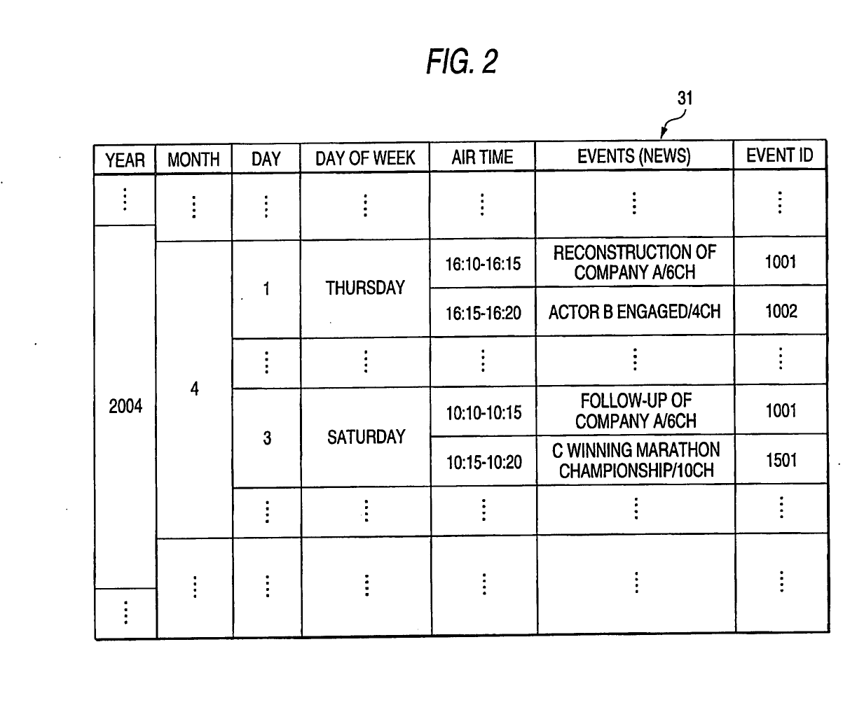

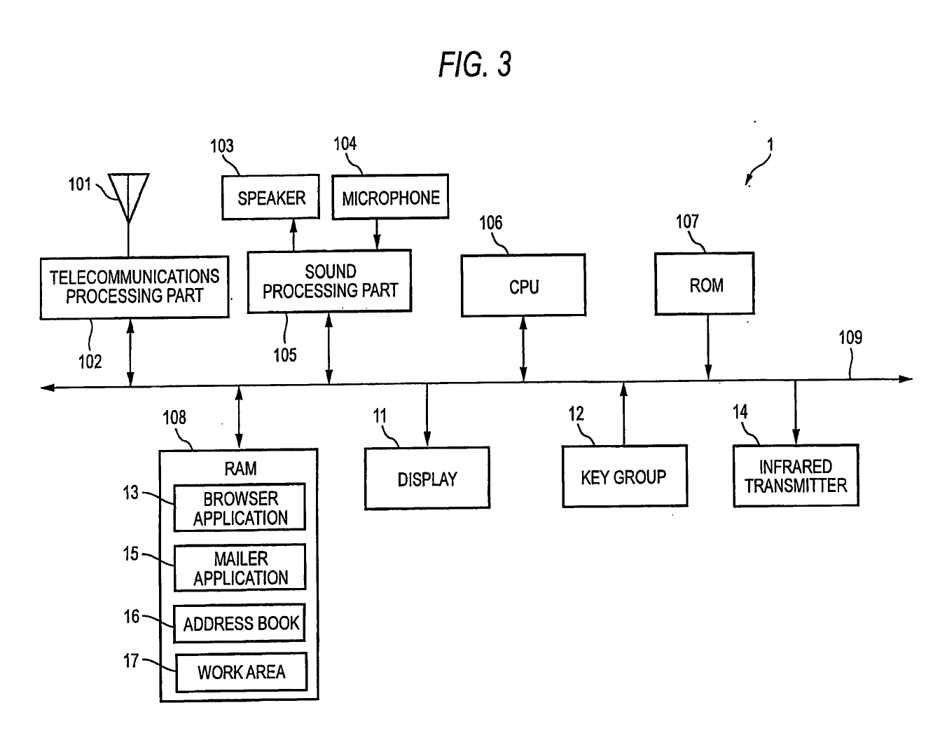

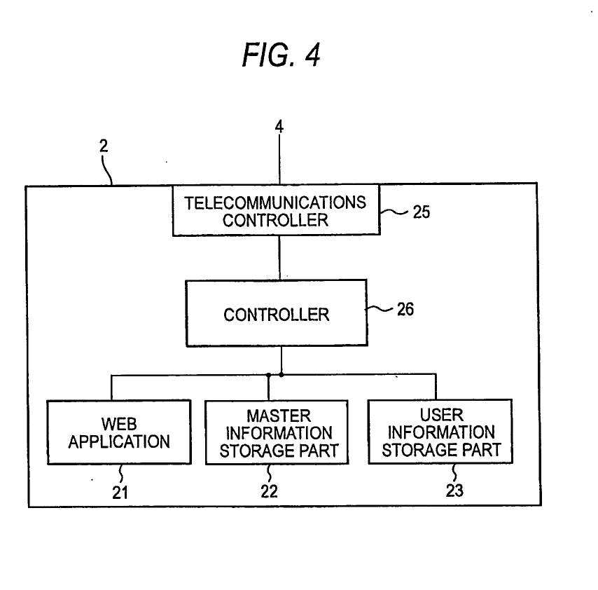

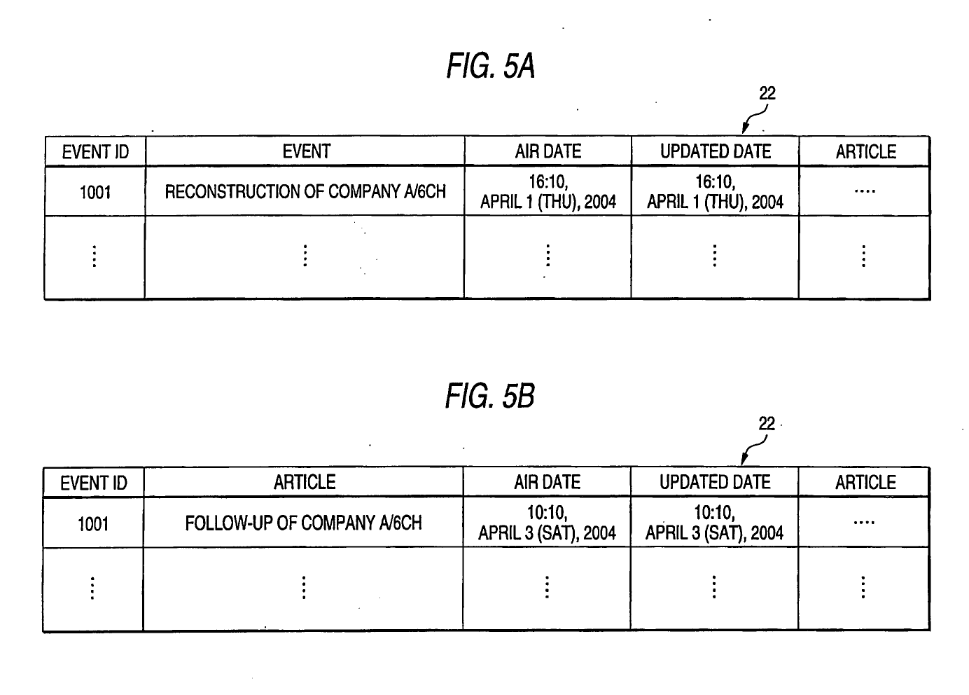

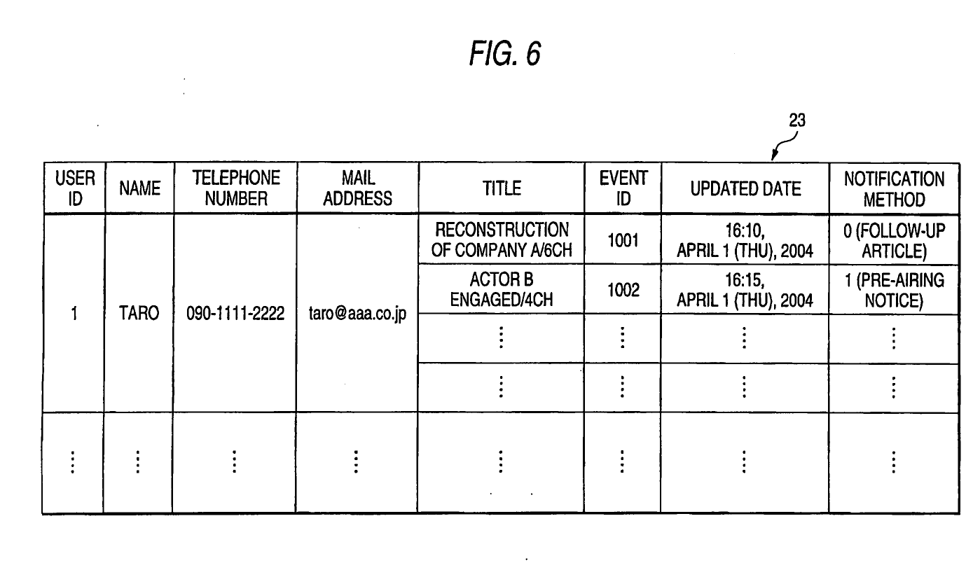

An embodiment of the present invention will now be described in detail with reference to the attached drawings. FIG. 1 is a drawing which shows one example of a network system which contains a news follow-up notifying system according to the embodiment, FIG. 2 is a drawing for describing a program schedule according to the embodiment, FIG. 3 is a block diagram which shows an example of the structure of a mobile phone according to the embodiment, FIG. 4 is a block diagram which shows an example of the structure of a server according to the embodiment, and FIG. 5 and FIG. 6 are drawings for describing information which is stored in the server.

In FIG. 1, reference numeral 1 denotes a mobile phone, 2 denotes a server, 3 is a broadcasting station control apparatus, 4 is the Internet, 5 is a base station, and 6 is a mobile telecommunications network. The mobile telecommunications network 6, the server 2 and the broadcasting station control apparatus 3 are connected to the Internet 4, for mutual telecommunications. The mobile phone 1 connects to the Internet 4 via the base station 5 which is connected to the mobile telecommunication network 6. When connected to the server 2 via the network, the mobile phone 1 can request for a notice of news follow-up. A television set 7 includes an infrared receiver 71.

The broadcasting station control apparatus 3 comprises a schedule database (DB) 31, as shown in FIG. 2 for instance. News events are registered in the schedule database 31 sequentially, along with the year, month, day, day of the week, and time of airing of the events. A unique ID is assigned to each event. For example, 1001 is assigned as the ID to the event “Reconstruction of Company A/6ch” and 16:10, Apr. 1 (THUR), 2004 is stored as the air date.

The mobile phone 1 is capable of reading web pages while connected to the server 2, and comprises a display 11 which shows a page provided by the server 2, a key group 12 or other input device for making entries on a page which appears on the display 11, a browser application 13 which displays a page provided from the server 2, an infrared transmitter 14 which sends out an infrared signal serving as an operation command to the television set.

As shown in FIG. 1 for example, the server 2 comprises a web application 21, a master information storage part 22, a user information storage part 23 and the like. Referring to the schedule database 31, the master information storage part 22 stores the IDs of events, the contents of the events, the airtimes, the updated dates and articles as necessary information. For example, 1001 is assigned as the ID to the event “Reconstruction of Company A/6ch” and 16:10, Apr. 1 (THUR), 2004 is stored as the air date as shown in FIG. 5. Since this event has not yet been updated, the air date and the updated date are the same. The most recent article or news relating to this event is stored in association with the above event information.

The user information storage part 23 stores user identification information, which is associated with users and specifies the mobile phones of the users and user contact information. To be more specific, as shown in FIG. 6, for the purpose of specifying a user, the user's name, telephone number, mail address and other information (e.g., postal address, bank account number) are stored in association with to the user ID. Additional information stored in association with the user ID are the title of an event for which the user requested the server 2 to provide follow-ups, the event ID, the updated date of the user's mobile phone and a flag indicating the notification method which is for providing selectable marks for a mail of follow-up notice or a pre-airing notice prior to TV broadcasting. In the example shown in FIG. 6, associated with the user ID are the name “TARO,” the telephone number “090-1111-2222” and the mail address “taro@aaa.co.jp.” Further, associated with the user ID are the title “Reconstruction of Company A/6ch” the event ID of 1001, the updated date of 16:10, Apr. 1 (THUR), 2004 and the notification method flag “0” which indicates that the user would like to receive a follow-up article by mail. As used herein, “mail” refers to electronic mail or e-mail.

Accordingly, event identification information is correlated with news events to be aired on TV, and stored in the master information storage part 22 of the server 2, making it possible to selectively provide news events stored in the master information storage part 22 when a request for the news events is received from the mobile phone. The user ID and address information of each user is correlated and stored in the user information storage part 23. When news is broadcast on TV, upon selection of an event with the mobile phone, the master information storage part 22 is accessed, the event ID associated with the selected event is read out and the read out event ID is stored in association with the user ID in the user information storage part 23 in the server 2. When an event stored in the master information storage part 22 is updated, the user information storage part 23 is accessed and matching of the event ID associated with the updated event is performed. When the matching identifies the event ID which matches, the user information storage part 23 is accessed, an address information associated with this matching event ID is extracted, and news information regarding the updated event is provided as a follow-up to the extracted address information.

The structure of the mobile phone 1 will now be described. FIG. 3 shows an example of the structure of the mobile phone 1 in detail. In this structure, a transceiver or telecommunications processing part 102, an audio processor or sound processing part 105, a CPU 106, a ROM 107, a RAM 108, a display 11, a key group 12 or other input device, an infrared transmitter 14 and the like are connected to an internal system bus 109, and transmission of a control signal and the like realizes various types of processing.

The telecommunications processing part 102 is connected to an antenna 101 and communicates with the mobile telecommunications network 6 via the antenna 101. The telecommunication processing part 102 is used for voice communications and telecommunications with the server 2, among other things. A speaker 103 for outputting voice and a microphone 104 for inputting voice are connected to the sound processing part 105, and the sound processing part 105 performs voice processing when telecommunications are performed.

The CPU 106 controls the mobile phone 1 in accordance with an operating system (OS) stored in the ROM 107. Programs including the pre-installed OS have been stored in the ROM 107. The CPU 106 executes various types of mobile applications (such as JAVA® applications, for instance). In addition, the CPU 106 receives inputs from the input device or key group 12, executes various types of processing, and controls the display 11.

The RAM 108 includes a work area 17 and stores a mailer application 15, an address book 16 and ring-tone melodies. The input device or key group 12 comprises various keys which permit entries of telephone numbers, addresses and the like and is also used for selecting and executing services, which will be described later. The display 11 displays images, operation guidance screens, and display screens of a general nature which are used for a telephone function, a mail function, etc.

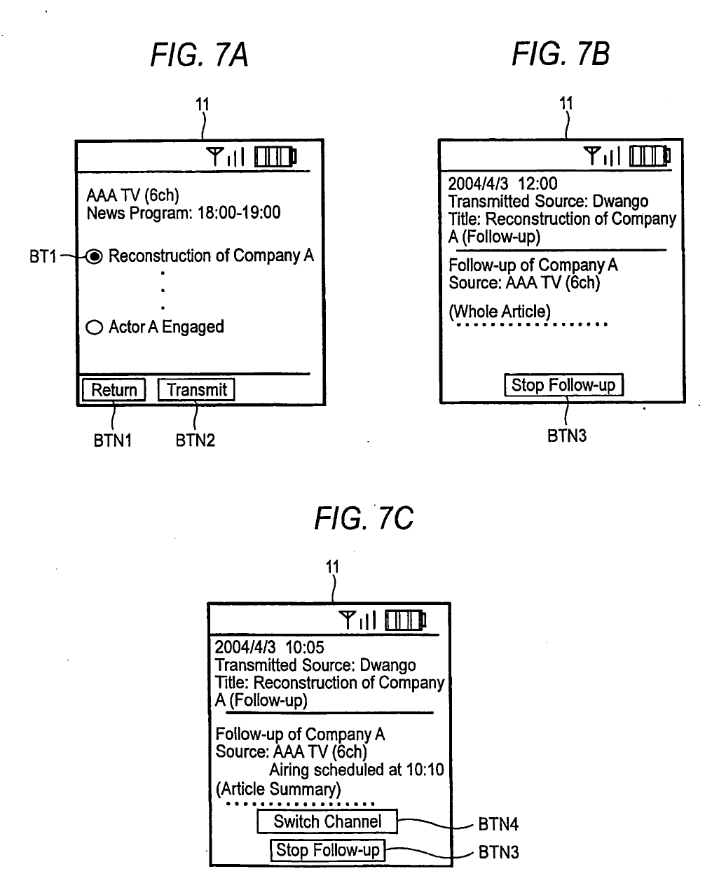

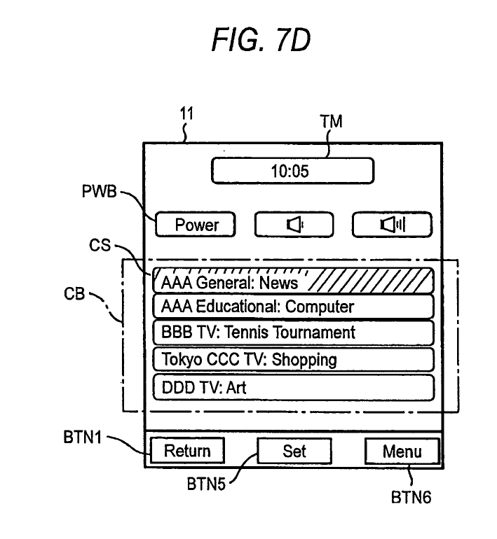

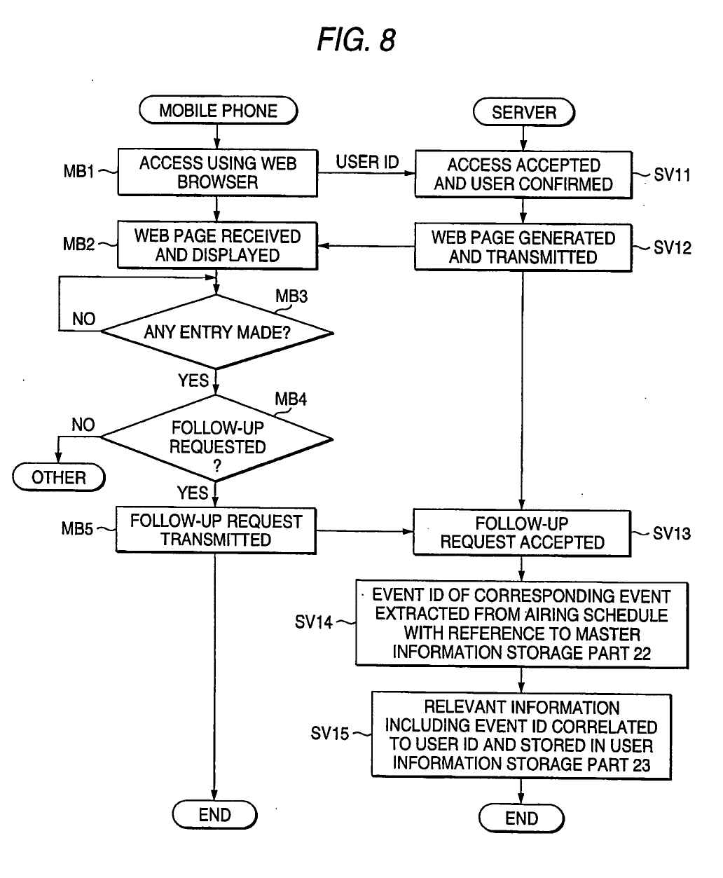

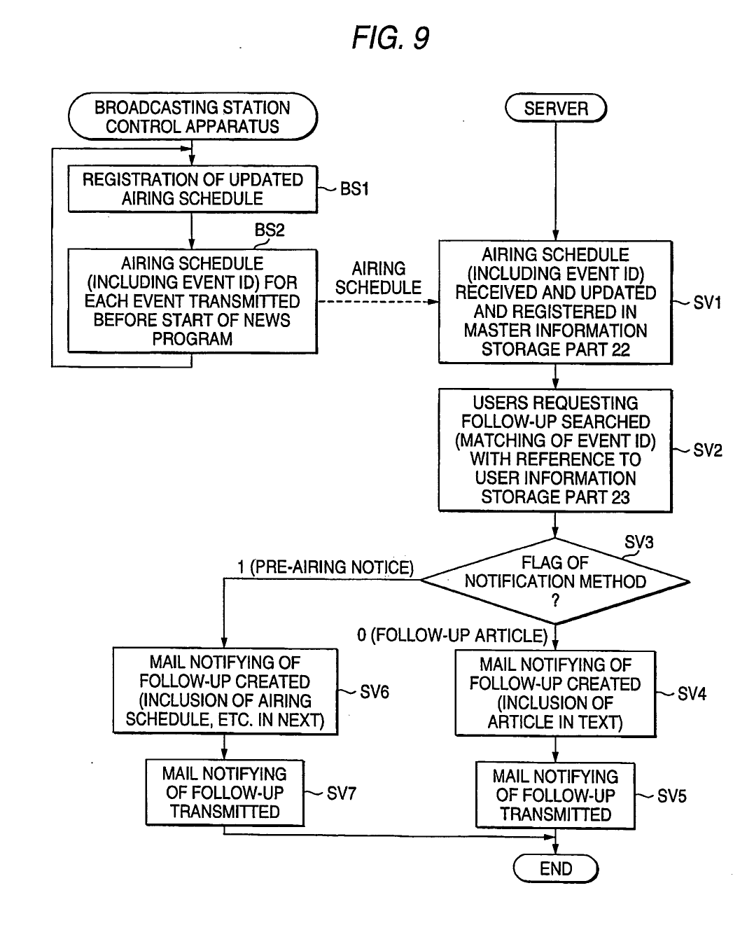

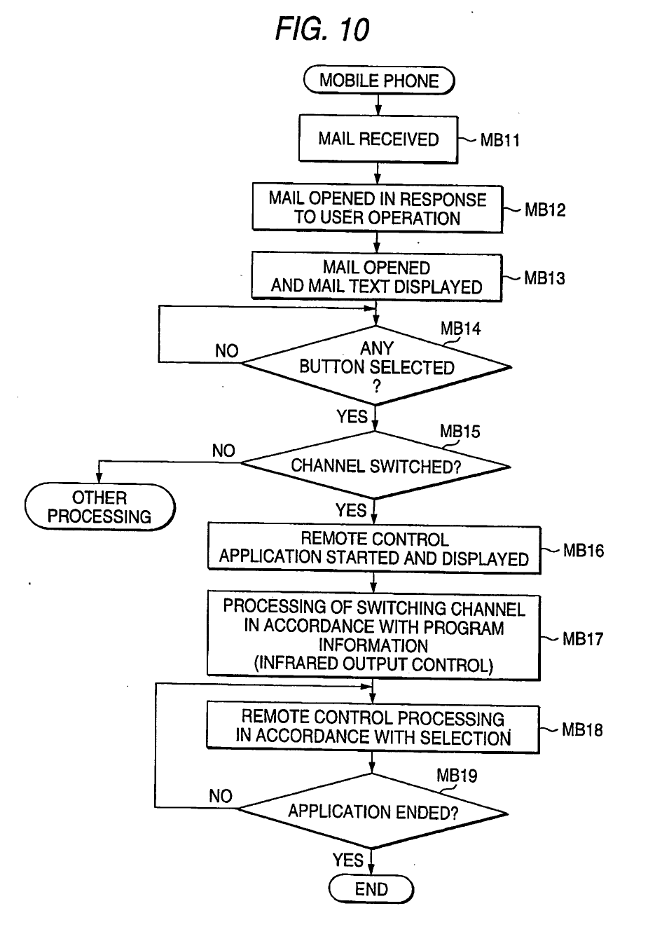

Operations will now be described with reference to FIGS. 7-10. FIG. 7 is a drawing for describing one example of screen change according to this embodiment, FIG. 8 is a flow chart for describing a follow-up requesting method according to this embodiment, FIG. 9 is a flow chart for describing update processing between the broadcasting station control apparatus and the server according to this embodiment, and FIG. 10 is a flow chart for describing a follow-up receiving method according to this embodiment.

First, when the mobile phone 1 accesses the server 2 (MB1), y access is accepted and a user is confirmed based on the user ID transmitted from the mobile phone 1 (SV11). Upon user confirmation, a web page compatible with the phone model which is used is created and sent to the mobile phone 1 (SV12). Upon receiving the web page, the mobile phone 1 shows this page in its display 11 (MB2).

The display 11 displays a page regarding TV news which is being currently aired as shown in FIG. 7(A) for instance. At this stage, reported on the television set 7 are events such as Reconstruction of Company A and Actor B Engaged. When an input mark BT1 calling for Reconstruction of Company A is selected and a TRANSMIT button BTN2 is operated on the mobile phone 1 (YES at MB3 and YES at MB4), a follow-up request is transmitted to the server 2 (MB5). When different operation is made (NO at MB4), other processing is executed.

The server 2 accepts the follow-up request (SV13), the master information storage part 22 is accessed, and the event ID referred to in the follow-up request is extracted from the airing schedule (SV14). Further, the user ID is associated with this event ID and stored in the user information storage part 23 (SV15), as shown in FIG. 6. This completes the request for the follow-up from the mobile phone 1 to the server 2.

The broadcasting station control apparatus 3 and the server 2 are constantly communicating with each other whether news regarding any event has been updated. In other words, the broadcasting station control apparatus 3 is always registering updates of the airing schedule (BS1) and sending to the server 2 the airing schedule for each event prior to the start of a news program (BS2). The schedule is transmitted at this stage and includes the event IDs, for the purpose of distinguishing individual events from each other.

As the airing schedule is sent from the broadcasting station control apparatus 3, the content stored in the master information storage part 22 of server 2 is updated based on this airing schedule. The user information storage part 23 is accessed and users who have requested follow-ups are searched for. The event ID is matched at this stage (SV2). With respect to those users who have requested follow-ups, notification flags are read in the user information storage part 23. If the notification flag is “0” (SV3), an article covering this event is read out, and a follow-up notice including this content is created (SV4) and delivered as a mail to the users (SV5).

If the notification flag is “1” (SV3), an article covering this event is read out, and a follow-up notice including a summary is created (SV6) and delivered as a mail to the users (SV7). Mail transmission is controlled so that these mails transmitted for this purpose will be delivered before the air time.

The mobile phone 1 receives the mail (MB11), and as the user opens the mail (MB12), the display 11 shows the content of the mail (MB13). When the notification method is one calling for follow-up articles, as shown in FIG. 7(B) for instance, a complete article is contained in the text of the mail, along with a STOP FOLLOW-UP button BTN3, which is used to instruct the server 2 to discontinue news follow-ups for this event.

When the notification method is one calling for pre-airing notices, as shown in FIG. 7(C) for example, the text includes a SWITCH CHANNEL button BTN4. A STOP FOLLOW-UP button BTN3 is also included for discontinuing news follow-ups.

When button (MB14) is selected and the selected button is the SWITCH CHANNEL button BTN4 (YES at MB15), a remote control application prepared in advance for the television set, for instance, starts up and an operation screen as that shown in FIG. 7(D) for example is displayed (MB16). If information regarding the channel is provided from the mail to the remote control application, within a channel select area CB, a cursor CS moves onto the channel for reporting the follow-up event. When a SET button BTN5 is operated, the TV switches to the channel pointed to by the cursor CS (MB17).

After this, remote control processing is executed in accordance with operations (MB18) and ends when an operation to end the remote control application is performed.

As described above, according to this embodiment, it is possible to easily obtain follow-ups of news which one reads and has an interest in, using his portable terminal.

It is noted that the foregoing examples have been provided merely for the purpose of explanation and are in no way to be construed as limiting of the present invention. While the present invention has been described with reference to certain embodiments, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular structures, materials, and embodiments, the present invention is not intended to be limited to the particulars disclosed herein; rather, the present invention extends to all functionally equivalent structures, method and uses, such as are within the scope of the appended claims.

1. A news follow-up notification system for use with a portable terminal in a telecommunications network, comprising:
a master information storage which stores event identification information correlated to news events aired on TV;
a news provider which selectively provides news information for individual news events stored in said master information storage, in response to a request from a portable terminal;
a user information storage which stores user identification information and correlated address information for registered users, reads event identification information associated with an event selected via said portable terminal from said master information storage, and stores said event identification information in association with said user identification information;
a matcher which, upon updating of an event stored in said master information storage, refers to said user information storage and identifies said event identification information associated with said updated event; and
a follow-up notifier which refers to said user information storage when said matcher has identified said event identification information, extracts address information associated with said identified event identification information, and provides notification of a follow-up news event using said extracted address information.

2. The news follow-up notifying system of claim 1, wherein said follow-up notifier notifies the portable terminal in the form of mail.

3. The news follow-up notifying system of claim 2, wherein said follow-up news event includes an article on said event, and said follow-up notifier embeds said article in the text of said mail.

4. The news follow-up notifying system of claim 2, wherein said follow-up news event includes an airing schedule of a program which provides a follow-up on said event, and said follow-up notifier provides said airing schedule of said program in the text of said mail.

5. The news follow-up notifying system of claim 4, wherein said follow-up notifier notifies prior to airing of said program.

6. A news follow-up notification method for use with a portable terminal in a telecommunications network, comprising:
storing, in a first memory, event identification information correlated to individual news events aired on TV;
selectively providing news event information stored in said first memory in response to a request from a portable terminal;
storing, in a second memory, user identification information and correlated address information for registered users;
reading out event identification information associated with an event selected via said portable terminal from said first memory;
storing said event identification information in association with said user identification information;
referring to said second memory upon updating of an event stored in said first memory and identifying event identification information associated with an updated event;
referring to said second memory when said event identification information has been identified;
extracting address information associated with said identified event identification information; and
providing notification of a follow-up news event regarding said updated event in accordance with said address information.

7. The news follow-up notifying method of claim 6, wherein notification is provided in the form of mail.

8. The news follow-up notifying method of claim 7, wherein said follow-up event includes an article on said event, and said article is embedded in the text of said mail.

9. The news follow-up notifying method of claim 7, wherein said follow-up news event includes an airing schedule of a program which provides a follow-up on said news event, and said airing schedule of said program is embedded in the text of said mail.

10. The news follow-up notifying method of claim 9, wherein notification is provided prior to airing of said program.

11. A news follow-up notifying program which can be executed by a computer on a server which communicates with a portable terminal via a network, wherein said news follow-up notifying program comprises:
storing, in a first memory, individual event identification information related to news information aired on TV;
selectively providing individual news event information stored in said first memory to a portable terminal in response to a request from the portable terminal;
storing, in a second memory, user identification information and correlated address information for each registered user;
when an event is selected by the portable terminal, reading out event identification information associated with the event selected from said first memory;
storing said event identification information thus read in association with said user identification information;
referring to said second memory upon updating of an event stored in said first memory;
matching the event identification information with the updated event;
referring to said second memory when matching event identification information has been obtained;
extracting address information associated with the matching event identification information; and
notifying, as a follow-up, news information regarding the updated event in accordance with the extracted address information.

12. The news follow-up notifying program of claim 11, wherein notification is provided in the form of mail.

13. The news follow-up notifying program of claim 12, wherein said news information includes an article on said event, and said article is embedded in the text of said mail.

14. The news follow-up notifying program of claim 12, wherein said news information includes an airing schedule of a program which will give a follow-up on said event, and said airing schedule of said program is embedded in the text of said mail.

15. The news follow-up notifying program of claim 14, wherein notification is provided prior to airing of said program.
